(19) United States
(12) Patent Application Publication
(10) Pub. No.: US 2018/0311800 A1
(43) Pub. Date: Nov. 1, 2018

(54) ROTARY TORQUE BOOSTING DEVICE

(71) Applicant: CHINA PNEUMATIC CORPORATION, TAOYUAN CITY (TW)

(72) Inventor: YU-WEI CHU, TAOYUAN CITY (TW)

(21) Appl. No.: 15/583,080

(22) Filed: May 1, 2017

(51) Int. Cl. B25B 23/00; B25B 21/02

(52) U.S. Cl. CPC B25B 23/0035; B25B 21/02

(57) ABSTRACT

A method and a rotary torque boosting device used with a power rotary type impact wrench boost the output torque to drive a socket or fastener during operation. The rotary torque boosting device includes a main body with an input member having an input recess for receiving the anvil of the impact wrench, an output member having an output anvil for receiving the socket or fastener and a detachable disc exterior inertia member, to be secured with a retaining device for easy replacement. The inertia member is designed with a various moment of inertia and detachable to be assembled on the exterior surface of the main body for increasing the output torque of the tool during operation.

### FIELD OF THE INVENTION

The present invention relates to a rotary torque boosting device. More particularly, to a device that includes an exchangeable disc exterior inertia member to provide various amounts of rotary inertia which can be selectively coupled with different size sockets. So as to be used with power impact tools for effectively boosting the output torque of the tool during bolt tightening and loosening operations.

### BACKGROUND OF THE INVENTION

A power impact tool, also briefly referred to as an impact wrench herein, is a tool been widely used in the industrial field for tightening and loosening screws or bolts. This type of tool includes an impact mechanism provided at an output member thereof. When the impact wrench operates, it uses the rotary inertia produced during the rotational movement thereof to strike an output shaft and therefore drives a socket, so as to tighten or loosen a bolt. US Patent Application Publication No. 2012/0255749A1, and its corresponding Chinese Patent Application Publication No. CN 103648726A disclose a rotary impact device, which can indeed effectively boost the output torque of an impact tool, such as an impact wrench. However, each piece of the rotary impact device can only be applied to one single bolt size. Therefore, an operator has to keep sufficient inventory of rotary impact devices in different sizes. That is, the rotary impact device disclosed in US 2012/0255749A1, and CN 103648726A is of course, inconvenient for use and largely increases the user's burden.

In practical operation, the output member of the same impact wrench is usually to be used with different size sockets. Thus the inventor developed an improved rotary torque boosting device to overcome the drawbacks of the prior art mentioned above. So, a user may conveniently exchange differently sized disc exterior inertia members for the rotary torque boosting device according to the torque required to be boosted and exchange the disc exterior inertia members while utilizing different size sockets at hand to lower the user's burden on inventory management and usage cost, making the rotary torque boosting device more practical for use and popular in the industrial field.

### SUMMARY OF THE INVENTION

In view of the shortcomings of the prior art (rotary impact device), it is a primary object of the present invention to develop a rotary torque boosting device to enable a user conveniently exchange the disc exterior inertia members for the rotary torque boosting device according to the torque required to be boosted and exchange the disc exterior inertia members while utilizing different size sockets at hand to lower the user's burden of inventory management and usage cost.

To achieve the object above and others, the rotary torque boosting device according to the present invention includes a rotary shaft, a disc exterior inertia member, and a retaining device. The rotary shaft has an input member configured for connecting to an output member of a power impact tool, an output member configured for connecting to an input member of a socket, and a first engagement section. The disc exterior inertia member is formed at a center with a second engagement section for correspondingly engaging with the first engagement section of the rotary shaft and is a structure in axial symmetry about an axis of rotation of the rotary shaft. Moreover, the retaining device is configured for fitting onto the rotary shaft to retain the disc exterior inertia member to the rotary shaft.

The rotary shaft for the rotary torque boosting device of the present invention is provided around a free end of the first engagement section with a retaining groove, into which the retaining device is fitted to retain the disc exterior inertia member to the rotary shaft. According to the rotary torque boosting device of the present invention, the first engagement section of the rotary shaft can be a regular polygonal engagement section, a splined engagement section, a key-slot engagement section or a threaded engagement section; and the second engagement section is structured and sized corresponding to the first engagement section.

According to the rotary torque boosting device of the present invention, the input member of the rotary shaft can be differently sized and shaped to adapt to a size and shape of the output member of the power impact tool; and the output member of the rotary shaft can be differently sized and structured to adapt to the input member of the socket.

According to an operable embodiment of the rotary torque boosting device of the present invention, the output member of the rotary shaft can have a specific size and shape to adapt to a bolt having an equal size and shape.

According to an operable embodiment of the rotary torque boosting device of the present invention, the disc exterior inertia member includes a plurality of inertia adjustment openings, which are arranged in axial symmetry about an axis of rotation of the rotary shaft.

According to an operable embodiment of the rotary torque boosting device of the present invention, the retaining device is to be adapted to a retaining groove formed on the free end of the rotary shaft. Moreover, according to another operable embodiment of the present invention, the retaining device can be a nut corresponding to a threaded structure formed at the first engagement section for retaining the disc exterior inertia member to the rotary shaft.

In summary, the rotary torque boosting device of the present invention can be used to provide different amounts of rotary inertia, so that a user can use it with different size sockets at hand to perform bolt tightening and loosening operations in a more flexible and cost-effective manner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a comparative view of a conventional socket, a prior art rotary impact device and a rotary torque boosting device of the present invention, all designed for use with a power impact tool;

FIG. 2 is an exploded cutaway view of a rotary torque boosting device according to a first preferred embodiment of the present invention;

FIG. 3 is an assembled cutaway view of the rotary torque boosting device of FIG. 2, viewed from an end thereof;

FIG. 4 is an assembled partially sectioned side view of the rotary torque boosting device of FIG. 2;

FIG. 5 is an assembled cutaway view of the rotary torque boosting device of FIG. 2, viewed from another end thereof;

FIG. 6 is an exploded perspective view of a rotary torque boosting device according to a second preferred embodiment of the present invention;

FIG. 7 is an assembled side view of the rotary torque boosting device of FIG. 6;

FIG. 8 is an assembled sectional view of the rotary torque boosting device of FIG. 6;

FIG. 9 is an exploded perspective view of a rotary torque boosting device according to a third preferred embodiment of the present invention;

FIG. 10 is an assembled side view of the rotary torque boosting device of FIG. 9;

FIG. 11 is an assembled sectional view of the rotary torque boosting device of FIG. 9;

FIG. 12 is an exploded perspective view of a rotary torque boosting device according to a fourth preferred embodiment of the present invention;

FIGS. 13 and 13A to 13D illustrate some feasible designs for a disc exterior inertia member of the rotary torque boosting device according to the present invention; and

FIG. 14 is a flowchart showing the steps of testing and recording the torque boost gains from differently structured disc exterior inertia members for the rotary torque boosting device of the present invention.

### DETAILED DESCRIPTION OF THE PREFERRED EMBODIMENTS

The present invention describes some preferred embodiments thereof by referring to the accompanying drawings.

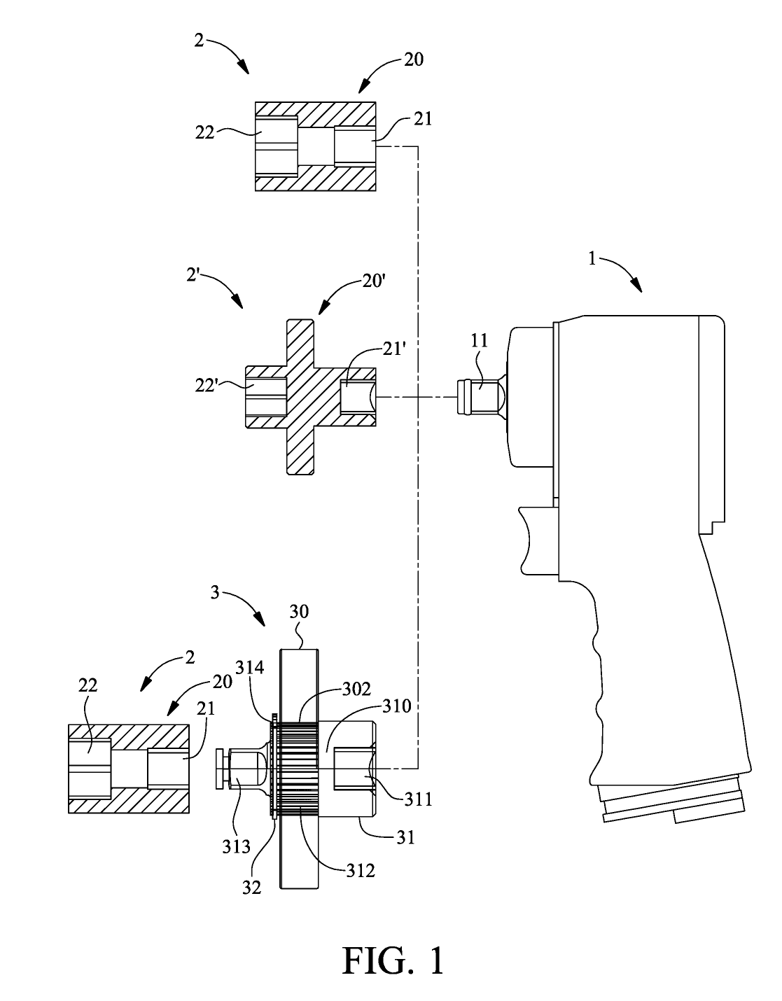

Please refer to FIG. 1, which is a comparative view of a conventional socket 2, a prior art rotary impact device 2′ and a rotary torque boosting device 3 of the present invention, all designed for use with a power impact tool 1. As shown in the drawing, when using the conventional socket 2 with the power impact tool 1, an output member 11 of the power impact tool 1 is to be inserted into an input recess formed at an input member 21 of the socket 2 to drive a bolt (not shown). The bolt head will be fitted to an output member 22 of the socket 2, for loosening or tightening the bolt. The prior art rotary impact device 2′ is formed by providing a main body 20 of the conventional socket 2 with an inertia member 20′, which is coaxial with a centerline of the main body 20 and radially outward extended from the main body 20. The prior art rotary impact device 2′ has an input member 21′ and an output member 22′, which are the same as the input member 21 and the output member 22, respectively, of the conventional socket 2. However, when the prior art rotary impact device 2′ is used with the power impact tool 1, the radially outward extended inertia member 20′ gives the rotary impact device 2′ an increased mass as well as an increased moment of inertia induced by the outward shifted center of mass, which together enable increased rotary inertia during a rotary impact motion and accordingly, increased output torque of the power impact tool 1. This effect has been clearly disclosed in US 2012/0255749A1 and CN 103648726A, as having been mentioned in the section of “Background of the Invention” herein. However, the prior art rotary impact device 2′ requires much higher manufacturing cost than that of the conventional socket 2. Besides, just like the conventional socket 2, the prior art rotary impact device 2′ is designed for use with the bolt in a one-to-one correspondence, which will inevitably increase the users' burden and inconvenience in using it. On the other hand, the rotary torque boosting device 3 according to the present invention has thoroughly overcome the above shortcomings. More specifically, the rotary torque boosting device 3 of the present invention is a knockdown structure, which is obtained by modifying the structure of the prior art rotary impact device 2′. More specifically, the rotary torque boosting device 3 includes a rotary shaft 31 and an exchangeable disc exterior inertia member 30 detachably assembled to the rotary shaft 31. The disc exterior inertia member 30 can be differently sized and has a second engagement section 302 for engaging with a first engagement section 312 formed on the rotary shaft 31, and a retaining device 32 can be fitted in a retaining groove 314 on the rotary shaft 31 to releasably retain the disc exterior inertia member 30 to the rotary shaft 31, enabling convenient assembling and removal of the disc exterior inertia member 30 to and from the rotary shaft 31. The rotary shaft 31 has a main body 310, which has an input member 311 with an input recess the same as the input member 21 of the conventional socket 2 and an output member 313 the same as the output member 11 of the power impact tool 1 in size. Therefore, the output member 313 of the rotary torque boosting device 3 can be used with conventional sockets 2 that have the same sized input members 21 but differently sized output members 22. In this manner, a user needs only to prepare a one-size rotary shaft 31 for selectively engaging with disc exterior inertia members 30 of different amounts of rotary inertia and using with existing sockets 2 of different specifications and sizes. The disc exterior inertia member 30 can be conveniently replaced with different size while dramatically reducing the usage cost of the rotary torque boosting device of the present invention.

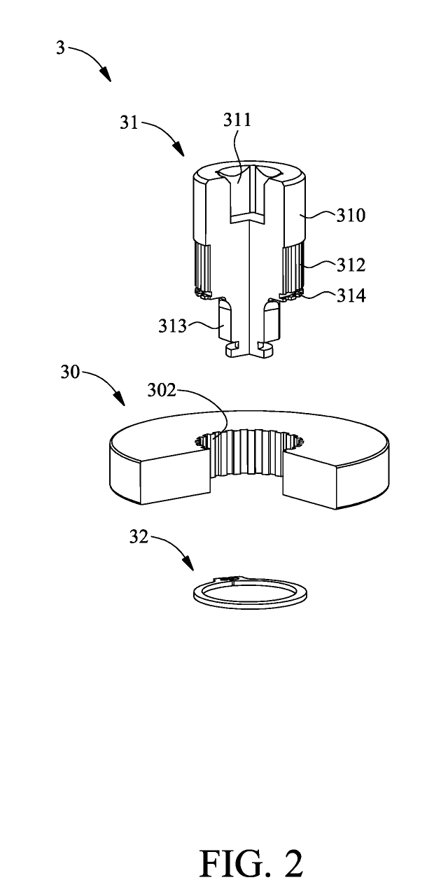

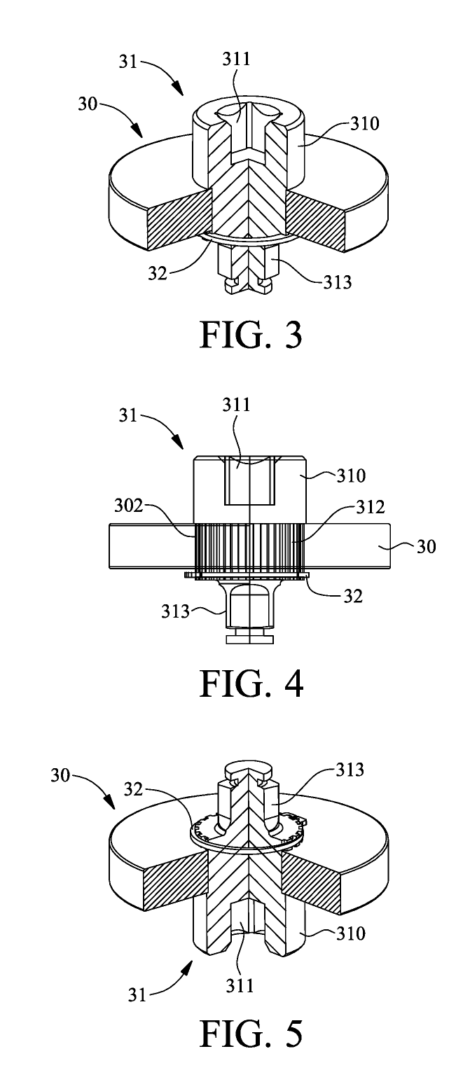

Please refer to FIGS. 2 to 5, which are exploded and assembled cutaway views of a rotary torque boosting device 3 according to a first preferred embodiment of the present invention. As shown, the rotary torque boosting device 3 is assembled from a rotary shaft 31, a disc exterior inertia member 30 and a retaining device 32. The rotary shaft 31 has an input member 311, an output member 313 and a first engagement section 312. The input member 311 is configured for connecting to an output member 11 of a power impact tool 1. The input member 311 may be differently sized and shaped to adapt to the size and shape of the output member 11 of the power impact tool 1. The output member 313 is configured for connecting to an input member 21 of a socket 2. Similarly, the output member 313 may be differently sized and structured to adapt to the input member 21 of the socket 2. Further, the output member 313 may be otherwise specifically sized and shaped to adapt to a bolt having correspondingly specific size and shape. The first engagement section 312 is configured for engaging with a second engagement section 302 formed at a center of the disc exterior inertia member 30. The retaining device 32 is fitted onto the rotary shaft 31 to retain the disc exterior inertia member 30 to the rotary shaft 31. For example, the retaining device 32 can be fitted in a retaining groove 314 formed around a free end of the first engagement section 312 of the rotary shaft 31 to enable convenient removal, assembling and replacement of the disc exterior inertia member 30. The first engagement section 312 and the second engagement section 302 are configured to prevent the rotary shaft 31 and the disc exterior inertia member 30 from rotating about each other. The disc exterior inertia member 30 is in axial symmetry about an axis of rotation of the rotary shaft 31. The retaining device 32 can be a C type retaining ring. The retaining device 32, coupled with the retaining groove 314 to prevent the second engagement section 302 of the disc exterior inertia member 30 from disengaging the first engagement section 312 of the rotary shaft 31 axially from each other when the power impact tool 1 operates. Thus the rotary torque boosting device 3 of the present invention can be mounted to between the output member 11 of the power impact tool 1 and the socket 2 to effectively increase the rotary inertia and accordingly boost the output torque of the power impact tool 1 during operation. With the present invention, the same one rotary torque boosting device can be used to couple with differently sized sockets; and differently sized disc exterior inertia members can be selectively assembled to the rotary shaft to achieve required boosting of rotary torque, enabling the bolt tightening and loosening operations to be performed in a flexible and cost-effective manner.

Preferably, the first engagement section 312 of the rotary shaft 31 of the rotary torque boosting device 3 can also be engaged with the second engagement section 302 of the disc exterior inertia member 30 via a threaded structure. Then, a nut (not shown) instead of the C type retaining ring 32 is used to tighten the disc exterior inertia member 30 against the rotary shaft 31, lest the disc exterior inertia member 30 should become loosened from the rotary shaft 31.

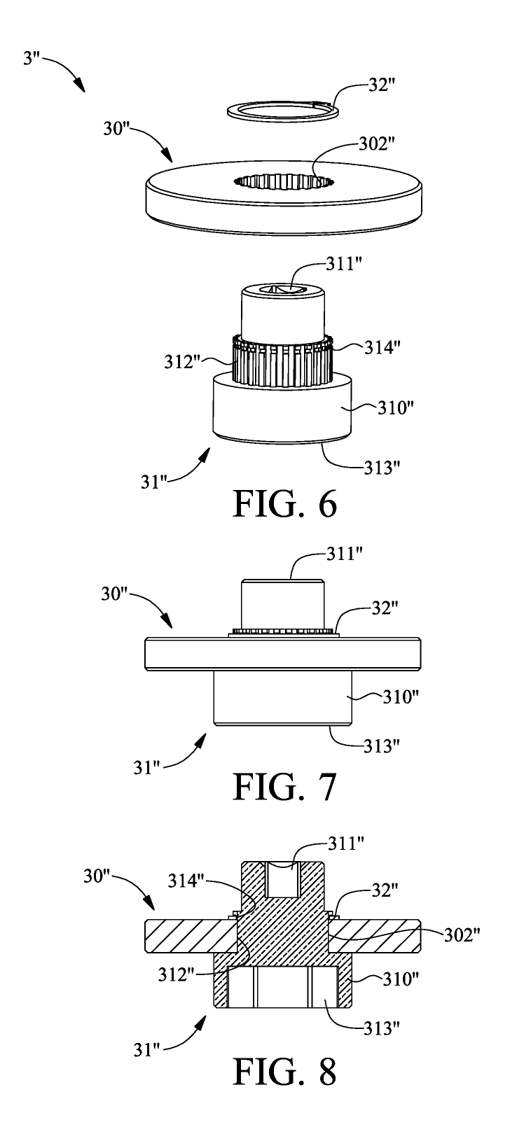

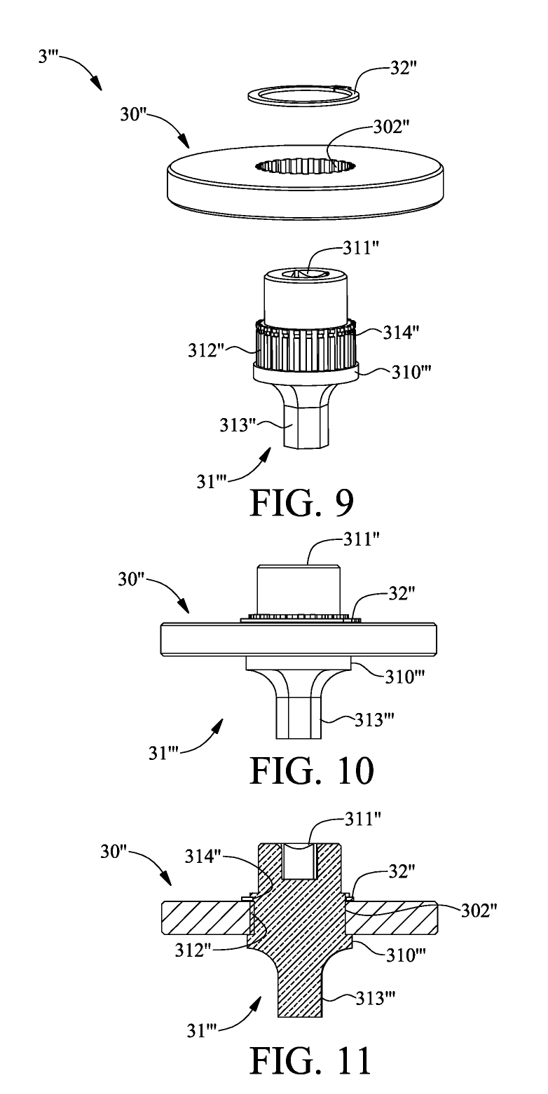

Please refer to FIGS. 6 to 11, which are exploded perspective view, assembled side view and assembled sectional view, respectively, of a rotary torque boosting device 3″ according to a second preferred embodiment of the present invention. The rotary torque boosting device 3″ is assembled by engaging a first engagement section 312″ of a rotary shaft 31″ with a second engagement section 302″ of a disc exterior inertia member 30″, and then using a retaining member 32″ to retain the disc exterior inertia member 30″ to the rotary shaft 31″. In the second preferred embodiment, the first and the second engagement section 312″, 302″ are respectively a splined engagement section. The rotary shaft 31″ has an input member 311″, which can be the same as the input member 311 shown in FIG. 2. The rotary shaft 31″ has a main body 310″ with an output member 313″, which can be, for example, configured as a female hexagon as shown in FIG. 8, to adapt to a male hexagonal head of a bolt to be tightened. FIGS. 9 to 11 are exploded perspective view, assembled side view and assembled sectional view, respectively, of a rotary torque boosting device 3′″ according to a third preferred embodiment of the present invention, which includes a rotary shaft 31′″ having a main body 310′″ with an output member 313′″. The output member 313′″ is configured as a male hexagon, as shown in FIG. 9, to adapt to a female hexagonal head of a bolt to be tightened. The disc exterior inertia member 30″ can be used with the rotary shaft in either the second or the third preferred embodiment. In other words, the disc exterior inertia member 30″ can be so designed to be exchangeable in use, giving the present invention increased usability.

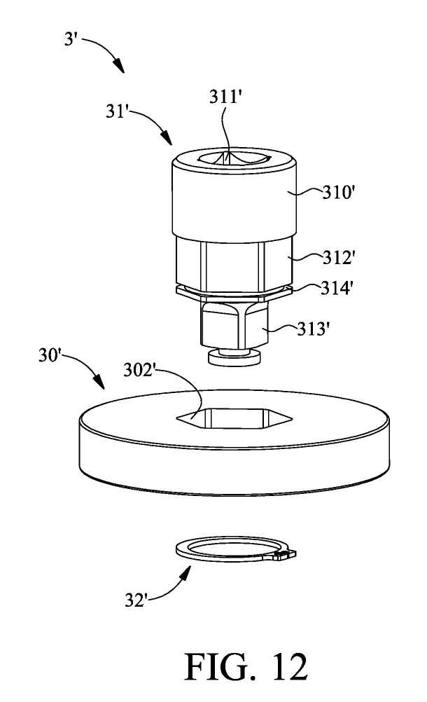

FIG. 12 is an exploded perspective view of a rotary torque boosting device 3′ according to a fourth preferred embodiment of the present invention, which includes a rotary shaft 31′, a disc exterior inertia member 30′ and a retaining device 32′. The rotary shaft 31′ has a first engagement section 312′ in the form of a regular hexagonal structure for correspondingly engaging with a second engagement section 302′ of the disc exterior inertia member 30′, and a retaining groove 314′ is formed at a free end of the first engagement section 312′. The retaining device 32′ is to be fitted in the retaining groove 314′. In other variations of the fourth preferred embodiment, the first and the second engagement section 312′, 302′ can be other regular polygons in shape or can be a key-slot structure. The rotary shaft 31′ has an output member 313′, which can be configured as a regular polygonal structure or a spline structure in correspondence to the specification and size of the input member 21 of the conventional socket 2. Alternatively, the output member 313′ can be directly manufactured into a specific size corresponding to the form of the head of a bolt to be tightened, just like the output member 22 of the conventional socket 2.

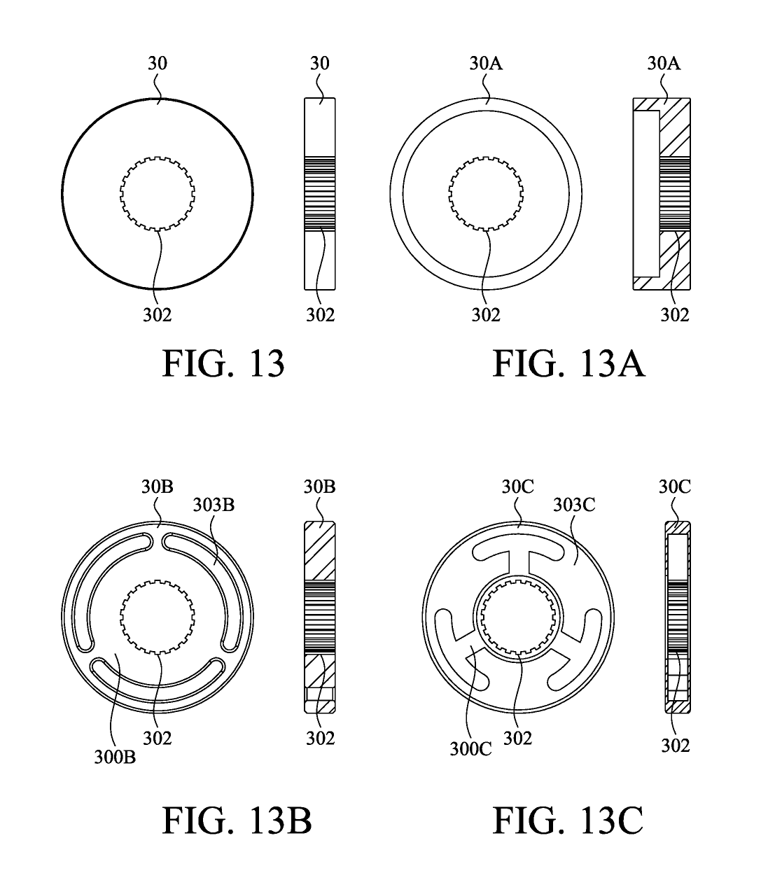

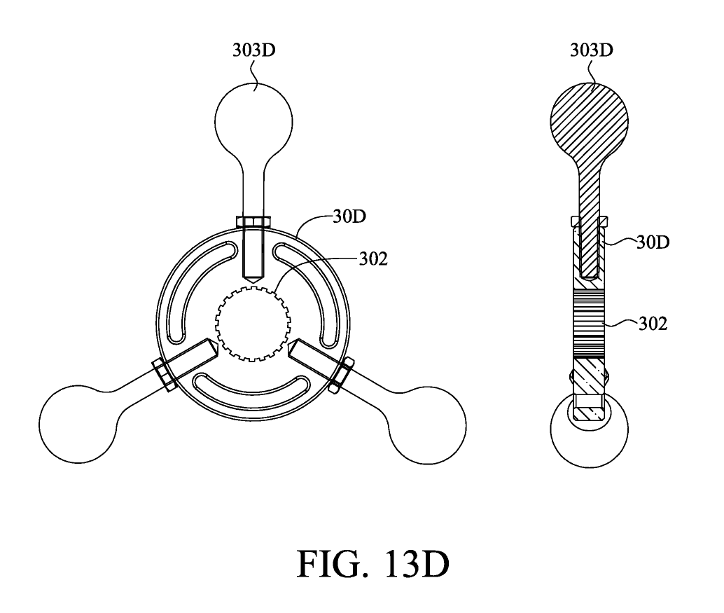

Referring to FIGS. 13 and 13A to 13D, which illustrate some feasible designs for the disc exterior inertia member of the rotary torque boosting device according to the present invention, such as disc exterior inertia members 30, 30A, 30B, 30C, and 30D. While the second engagement sections 302 of disc exterior inertia members 30, 30A, 30B, 30C, and 30D have the same size, and all are of a spline structure for coupling with the first engagement section 312 of the rotary shaft 30 shown in FIG. 2, the disc exterior inertia members 30, 30A, 30B, 30C, and 30D, can be differently shaped to provide different amounts of rotary inertia for use. Compared to the disc exterior inertia member 30 shown in FIG. 13, the disc exterior inertia member 30A shown in FIG. 13A further includes an axially raised outer peripheral edge and accordingly has an outward shifted center of mass, which enables the disc exterior inertia member 30A having a limited outer diameter to have effectively increased rotary inertia; the disc exterior inertia member 30B shown in FIG. 13B further includes three inertia adjustment openings 303B, which are axially symmetrically arranged and angularly equally spaced on the disc exterior inertia member 30B and is also in axial symmetry about the axis of rotation of the rotary shaft 31; the disc exterior inertia member 30C shown in FIG. 13C is a metal structure 300C over molded with a shock-absorbing structure 303C, such as a rubber material, to achieve a shockproof effect; and the disc exterior inertia member 30D shown in FIG. 13D is formed by tightening three extension arms 303D to the main body 300B of the disc exterior inertia member 30B using bolts. The extension arms 303D are axially symmetrically arranged and angularly equally spaced on the disc exterior inertia member 30D to provide further increased rotary inertia. It is understood that more changes based on the above illustrated structural designs of the disc exterior inertia member can be carried out for satisfying different operating requirements.

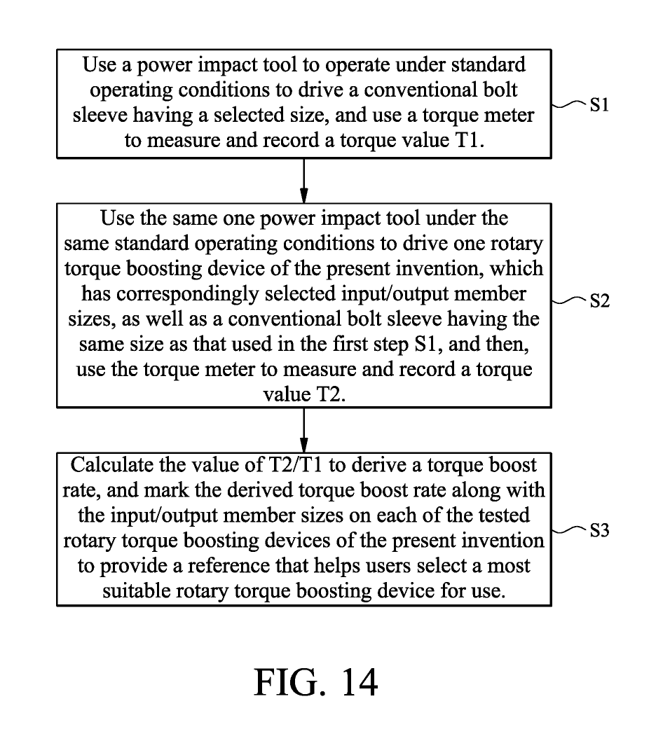

Please refer to FIG. 14, which is a flowchart showing the steps of testing and recording the torque boost gains from differently structured disc exterior inertia members for the rotary torque boosting device according to the present invention. The purpose of these testing and recording procedures is to provide users with a reference while selecting the rotary torque boosting device of the present invention. As shown, in a first step S1, a power impact tool is operated under standard operating conditions to drive a conventional socket having a selected size, and a torque meter is used to measure and record a torque value T1. In the second step S2, the same power impact tool is used under the same standard operating conditions to drive a rotary torque boosting device of the present invention, which has correspondingly selected input/output member sizes, as well as a conventional socket having the same size as that used in the first step S1, and then, use the torque meter to measure and record a torque value T2. And, in a third step S3, calculate the value of T2/T1 to derive a torque boost rate, and mark the derived torque boost rate along with the input/output member sizes on each of the tested rotary torque boosting devices of the present invention to provide a reference that helps users select a most suitable rotary torque boosting device they may require.

The present invention has been described with some preferred embodiments thereof and it is understood that the preferred embodiments are only illustrative and not intended to limit the present invention in any way and many changes and modifications in the described embodiments can be carried out without departing from the scope and the spirit of the invention that is intended to be limited only by the appended claims.

What is claimed is:

1. A rotary torque boosting device, comprising a rotary shaft, a disc exterior inertia member and a retaining device; the rotary shaft having an input member configured for connecting to an output member of a power impact tool, an output member configured for connecting to an input member of a socket, and a first engagement section; the disc exterior inertia member being formed at a center with a second engagement section for correspondingly engaging with the first engagement section of the rotary shaft and being a structure in axial symmetry relative to an axis of rotation of the rotary shaft; and the retaining device being configured for fitting onto the rotary shaft to retain the disc exterior inertia member to the rotary shaft.

2. The rotary torque boosting device as claimed in claim 1, wherein the rotary shaft is provided at a free end of the first engagement section with a retaining groove, into which the retaining device is fitted to retain the disc exterior inertia member to the rotary shaft; and wherein the first engagement section of the rotary shaft is selected from the group consisting of a regular polygonal engagement section, a splined engagement section, a key-slot engagement section or a threaded engagement section, and the second engagement section is structured and sized corresponding to the first engagement section.

3. The rotary torque boosting device as claimed in claim 1, wherein the input member of the rotary shaft can be differently sized and shaped to adapt to a size and shape of the output member of the power impact tool; and the output member of the rotary shaft can be differently sized and structured to adapt to the input member of the socket.

4. The rotary torque boosting device as claimed in claim 3, wherein the output member of the rotary shaft can have a specific size and shape to adapt to a bolt having a corresponding specific size and shape.

5. The rotary torque boosting device as claimed in claim 1, wherein the disc exterior inertia member includes a plurality of inertia adjustment openings, which are arranged in axial symmetry about an axis of rotation of the rotary shaft.

6. The rotary torque boosting device as claimed in claim 1, wherein the retaining device is adapted to a retaining groove formed on the rotary shaft or is a nut corresponding to a threaded structure formed at the first engagement section for retaining the disc exterior inertia member to the rotary shaft.
